(19) United States
(12) Patent Application Publication
(10) Pub. No.: US 2002/0138486 A1
(43) Pub. Date: Sep. 26, 2002

(54) System and method for providing web browser trail markers

(76) Inventor: Michael L. Rishel, Star, ID (US)

Correspondence Address: HEWLETT-PACKARD COMPANY, Intellectual Property Administration, P.O. Box 272400, Fort Collins, CO, 80527-2400, US

(21) Appl. No.: 09/802,447

(22) Filed: Mar. 9, 2001

(51) Int. Cl. G06F 17/30

(52) U.S. Cl. 707/10

(57) ABSTRACT

A system and method for providing web browser trail markers are disclosed. The system includes a computer and a memory operable to store a single reference to a web page. The system also includes a browser coupled to the memory and operable to execute on the computer. The browser includes a first button and a second button, and, the browser, in response to activation of the first button, stores a reference to a currently accessed web page in the memory, and, in response to activation of the second button, accesses a web page referenced by the reference stored in the memory. The method includes providing a memory location operable to store a reference to electronic content. The method also includes providing a user interface that is operably coupled to the memory location. The user interface includes a first button and a second button, and the user interface is operable to display electronic content. The method further includes displaying a first electronic content in the user interface, wherein the first electronic content is located at a first reference, and storing the first reference in the memory location in response to activation of the first button. The method includes displaying a second electronic content in the user interface, wherein the second electronic content is located at a second reference, and displaying the first electronic content reference by the first reference stored in the memory location in response to activation of the second button.

### BACKGROUND

1. Field

The present invention relates generally to computer systems and, more particularly, to a system and method for providing a temporary bookmark to a browsed page of information.

2. Description of the Related Art

Advances in personal computer technology and the development of vast, distributed communication systems, such as the Internet, allow users to use computers to connect to the communication systems to access the electronic information made available through the communication systems. As increasing amounts of electronic information is made available through these communication systems, it is becoming more and more difficult for users to navigate through the continuously increasing amounts of electronic information.

A user executes an application program generally known as a browser (e.g., Netscape Navigator, Microsoft Explorer, etc.) on his or her personal computer to access and retrieve information on the Internet. Information on the Internet is typically provided through what are known as web pages. The browser provides a user interface where the user can specify a Uniform Resource Locator (URL) for the location of the desired web page. The URL specifies a network path to a server on which the web page is hosted or stored. A URL can vary from being relatively simple and brief, www.hp.com, to very long, www.shopping.hp.com/cgi-bin/hpdirect/shopping/scripts/home/which_home.jsp. As the complexity and length of the URLs increase, many users find it difficult to remember and enter the URLs of the desired web pages.

In an attempt to address this problem, browsers provide what are generally known as “bookmarks.” Bookmarks are used to mark favorite or desired web pages for subsequent retrieval, and are typically maintained in lists. For example, to create a bookmark for a favorite web page, a user can enter a URL in the browser to browse or visit the web page. Once there, the user can open a “Favorites” pull-down menu and select the “Add to Favorites” option. A pop-up window appears through which the user can add the URL of the current web page as a bookmark in the bookmark list.

Once created, the bookmarks are permanent in the bookmark list until removed. As the numbers of web sites and web pages continue to dramatically increase, so has the number of bookmarks in the bookmark list that a typical user maintains. It is not uncommon to find hundreds of bookmarks in a bookmark list. The long bookmark lists make it increasingly difficult for the user to find a desired bookmark in order to navigate to and browse the desired web page. Furthermore, if the user only wanted a temporary bookmark, for example, a bookmark for a web page that the user wants to conveniently return to during the current browsing session, the user has to first create the bookmark and, at the end of the browsing session, locate the bookmark in the bookmark list and remove the bookmark.

Conventional browsers provide “forward” and “back” buttons on the toolbar as another mechanism to enable a user to conveniently return to a previously visited or browsed web page. While the forward and back navigation option does not contribute to the growth of the bookmark list, the forward and back buttons only allow the user to navigate forward and backward one web page at a time. The user can find this to be very tedious. Also, if the user is browsing many web pages, the forward and back buttons may not enable the user to even tediously navigate back to a web page visited many pages previously.

Some browsers maintain a list of web pages visited by the user. These browsers typically track the web pages visited by the user and maintain the URLs of these pages in a sequential list. The list is typically short and maintains a record of the most recently visited web pages. Thus, the list is of no help to a user who wants to jump back many web pages.

Accordingly, what is needed is a system and method that allows a user to temporarily save or mark the address of a web page without contributing to the growth and unmanageability of conventional bookmark lists, and to conveniently return to the previously visited web page even after visiting a very large number of web pages.

### SUMMARY

The present disclosure is directed to a system and corresponding methods that facilitate the temporary storing of a network location during a browsing session for subsequent retrieval and use during the same browsing session. A user executes and utilizes a software program incorporating the present invention on, for example, his or her personal computer to browse a network, such as, by way of example, the World Wide Web (WWW or Web). The software program provides the user a user interface through which the user can navigate the network.

In one embodiment, the user uses the user interface and navigates to a location in the network. The user contents at the network location are displayed to the user through the user interface. Possibly wanting to conveniently return to this network location, the user can create a temporary trail marker for the current location by clicking on a button presented in the user interface. The user interface creates the trail marker by saving the current network location, for example, in memory. Subsequently, the user can navigate to other locations in the network. During the user's browsing session and, in particular, when the user want to return to the trail marked network location, the user can click on another button presented in the user interface to return to the trail marked location.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

In one embodiment, a web browser trail marker system includes a computer and a memory operable to store a single reference to a web page. The system also includes a browser coupled to the memory and operable to execute on the computer. The browser includes a first button and a second button, and, the browser, in response to activation of the first button, stores a reference to a currently accessed web page in the memory, and, in response to activation of the second button, accesses a web page referenced by the reference stored in the memory.

In another embodiment, a method for providing web browser trail markers includes: providing a memory location operable to store a reference to electronic content; providing a user interface operably coupled to the memory location, the user interface including a first button and a second button, the user interface operable to display electronic content; displaying a first electronic content in the user interface; the first electronic content located at a first reference; storing the first reference in the memory location in response to activation of the first button; displaying a second electronic content in the user interface, the second electronic content located at a second reference; and displaying the first electronic content reference by the first reference stored in the memory location in response to activation of the second button.

In still another embodiment, a computer-readable storage medium having stored thereon computer instructions that, when executed by a computer, cause the computer to: store a first reference to a first electronic content in a memory location, wherein the memory location being operable to store a single reference; display a second electronic content on a user interface, the second electronic content being associated with a second reference; provide a first button and a second button on the user interface; and display the first electronic content referenced by the first reference stored in the memory location on the user interface in response to activation of the first button.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

FIG. 1 illustrates an exemplary user interface window providing a web browser trail marker functionality, according to one embodiment.

FIG. 2 is a flow chart of an exemplary method for setting and activating a trail marker, according to one embodiment.

FIG. 3 illustrates one embodiment of an exemplary program logic that provides the web browser trail marker functionality.

FIG. 4 illustrates an exemplary browsing session in which a trail marker is activated, according to one embodiment.

FIG. 5 illustrates an exemplary browsing session in which a trail marker is set and subsequently activated, according to one embodiment.

### DETAILED DESCRIPTION

The present invention provides a web browser trail marker function for managing a browsing session. The web browser trail marker manages the Uniform Resource Locators (URLs) browsed or visited during a browsing session as a temporary bookmark. In one embodiment, the web browser trail marker functionality is incorporated into a user interface program, such as a browser, that generally functions to provide access to web pages. The web browser trail marker provides an efficient tool by which a user can return to a previously visited web page by simply clicking on a button or icon on a user interface.

For example, a user executes a user interface program that provides the trail marker functionality to browse to a desired web page or URL. The contents of the web page are displayed through a user interface that is displayed by the user interface program. Possibly wanting to return to the displayed web page, the user activates or clicks on a button or icon on the user interface to set a trail marker to the current web page. The user then browses to other web pages using the user interface. When the user wants to return to the trail marked web page, the user activates or clicks on an icon on the user interface to return to the trail marked location. The web page at the trail marked location is displayed in the user interface.

It should be appreciated by those skilled in the art that, although the invention is described herein in connection with trail marking a web page on the Web, the invention is readily adapted for use in trail marking electronic content other than a web page, such as, by way of example, an email message, a document, a file, and the like. Furthermore, the electronic content need not be located on the Web, but may be stored locally or on other types of networks, such as, by way of example, private networks, local area networks, wide area networks, and the like, that provide access to electronic content.

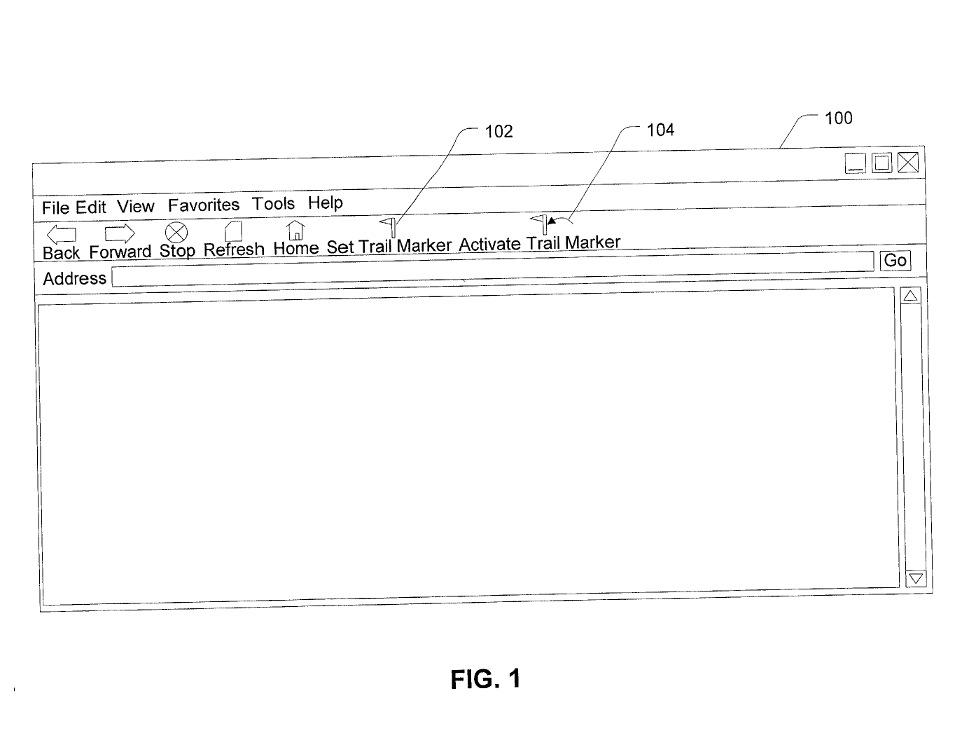

Referring now to the drawings, FIG. 1 illustrates an exemplary user interface window 100 providing a web browser trail marker functionality, according to one embodiment. As depicted, the user interface window 100 includes a set trail marker icon 102 and an activate trail marker icon 104. The web browser trail marker may operate in conjunction with a web browser that displays the contents of a web page in an organized manner.

As is generally known, a web browser is a software program that allows for the locating and viewing of the contents on the Internet. A user executes a web browser on, for example, a personal computer, to locate and view a web page. Two standard web browsers are the Netscape® Navigator developed by Netscape, Inc. or the Microsoft® Internet Explorer developed by Microsoft Corporation. One of skill in the art will appreciate that other types of software programs, such as, by way of example, other types of Internet browsers, custom browsers, communication software, user interface software, and the like, could also be used to implement a web browser.

In one embodiment, the trail marker functionality can be compiled into a browser program. The trail marker functionality as disclosed herein can be implemented as one or more software programs. The software programs can then be compiled with the software programs that comprise a standard web browser to create a web browser providing the trail marker functionality. In another embodiment, the trail marker functionality can be implemented as a software program that monitors the web pages accessed and displayed by a web browser. The software program can interact with the web browser to retrieve a URL for the currently displayed web page or pass to the web browser a URL of a web page to display.

For example, the trail marker functionality can be implemented as a Browser Helper Object (BHO) that executes with the Internet Explorer. The BHO can cause the web browser to display the icons for setting a trail marker and activating a trail marker on the web browser's command toolbar. The BHO can then interact with the web browser to retrieve the URL of the displayed web page when a user clicks the icon for setting a trail marker, or pass to the web browser a URL of a web page to display when the user clicks the icon for activating the trail marker. In the latter case, the URL contained in the trail marker is passed to the web page.

A user executes a web browser providing the web browser trail marker functionality on, for example, his or her user computer. When executing, the web browser may display the user interface window 100 in a display device coupled to the user computer. The user interface window 100 may initially display the contents of a “home page.” The user is then able to use the user interface window 100 to browse to and view the contents of other web pages. For example, the user can enter a URL for a web page in the user interface window 100 to display the contents of the web page at the specified URL location in the user interface window 100. As anther example, the user can use a coupled pointing device, such as a mouse or the like, to activate a hyperlink that is displayed in the user interface window 100 as part of the contents of a web page. The hyperlink is associated with a URL, and the user interface window 100 displays the contents of the web page at the URL location.

The set trail marker icon 102 sets or marks a URL as a trail marker. In one embodiment, activating the set trail marker icon 102 using a pointing device, such as a mouse or the like, causes the web browser to create a trail marker by storing the URL of the web page currently displayed in the user interface window 100. The URL can be stored in a memory location that is readily accessible to the web browser. Activating the activate trail marker icon 104 causes the web browser to retrieve from memory the URL stored as the trail marker and display the contents of the web page at the retrieved URL location in the user interface window 100.

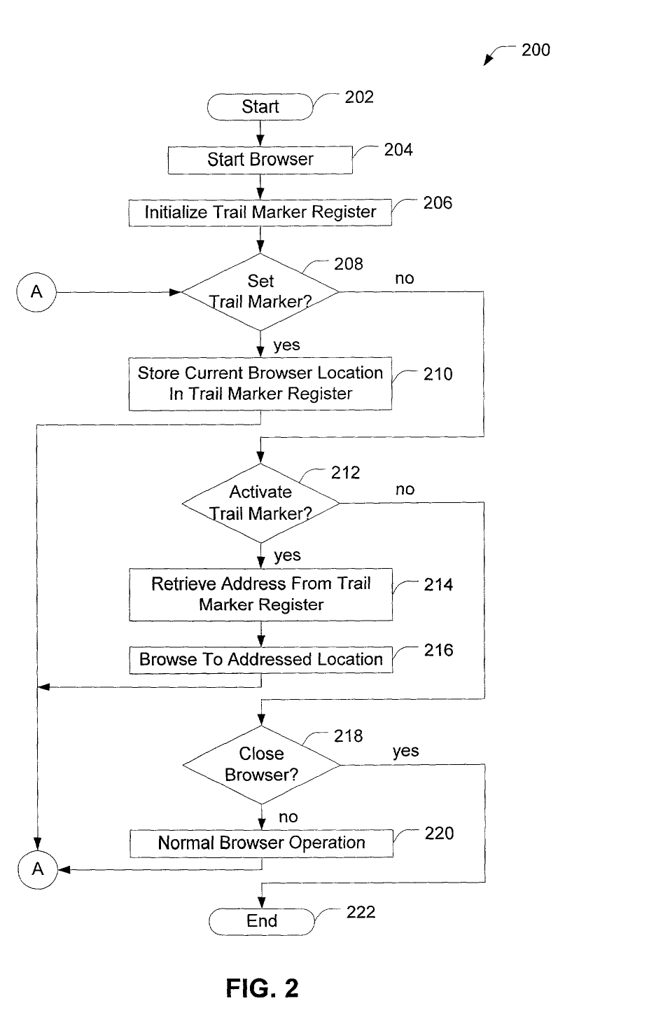

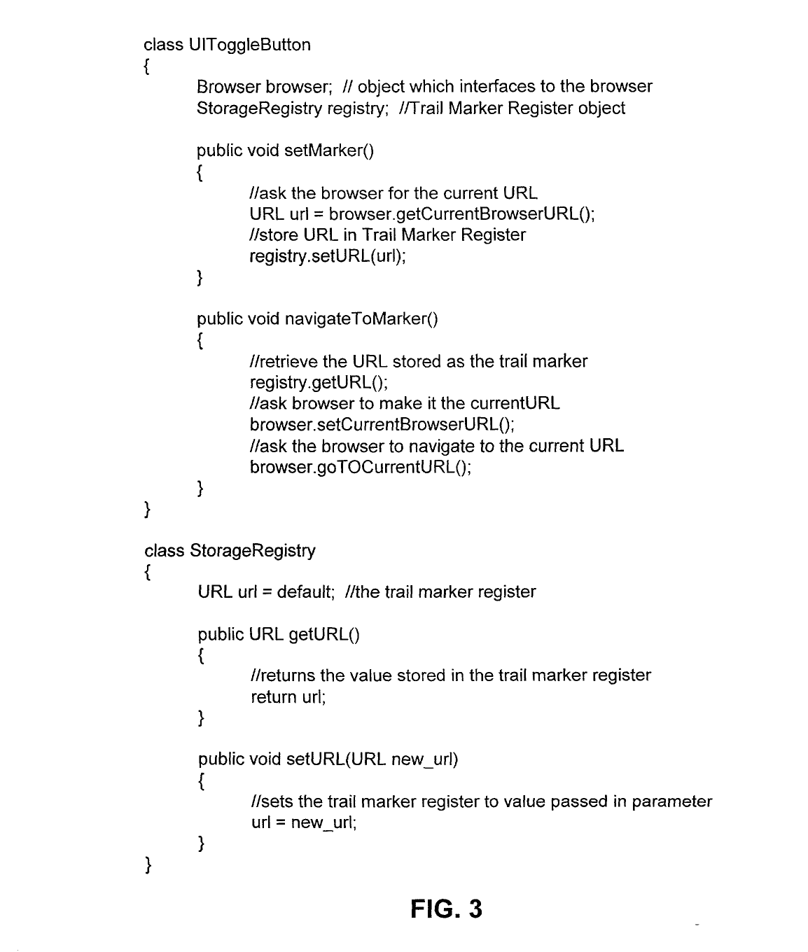

FIG. 2 is a flow chart of an exemplary method 200 for setting and activating a trail marker, according to one embodiment. Beginning at a start step 202, a user has access to a web browser program that provides the web browser trail marker functionality. The web browser program stores the URL in a trail marker register, which is a memory location that is readily accessible by the web browser program. FIG. 3 illustrates one embodiment of an exemplary program logic that provides the web browser trail marker functionality. The program logic works in conjunction with the web browser program, and generally f unctions to store a URL in a trail marker register and retrieve a URL from a trail marker register.

Referring again to FIG. 2, at step 204, the user starts a browsing session by executing the web browser on a computer. The web browser may display a user interface similar to the user interface window 100 (FIG. 1). At step 206, the web browser initializes the trail marker register. Because the trail marker register is initialized when the web browser first starts executing (e.g., at the beginning of a browsing session), the trail marker provides a temporary bookmark feature that lasts for the duration of the browsing session. In one embodiment, the URL of the home page that the web browser displays when it first starts executing is stored in the trail marker register. Here, the home page becomes the first trail marker. In another embodiment, the trail marker register is not initialized to a URL when the web browser first starts executing. Here, the trail marker register does not contain a valid URL until the user activates the set trail marker icon 102.

At step 208, the web browser determines if the user clicks or activates the set trail marker icon 102. If the set trail marker icon 102 is activated, the web browser, at step 210, executes a program module that facilitates the storing of the current browser location in the trail marker register. For example, activating the set trail marker icon 102 causes the setMarker function (FIG. 3) to execute. In particular, the setMarker function retrieves the URL of the web page currently displayed by the web browser, and stores the retrieved URL in the trail marker register variable. Having set the trail marker to the current URL displayed by the web browser, the web browser continues processing at step 208.

If, at step 208, the web browser determines that the set trail marker icon 102 is not activated, then, at step 212, the web browser determines if the user activates the activate trail marker icon 104. If the activate trail marker icon 104 is activated, the web browser, at step 214, executes a program module that facilitates the retrieving of an address from the trail marker register. At step 216, the web browser receives the retrieved URL (at step 214) and navigates to the address. In particular, the web browser displays the contents at the addressed location in the user interface window 100.

For example, activating the activate trail marker icon 104 causes the navigate ToMarker function (FIG. 3) to execute. The navigate ToMarker function retrieves the URL stored as the trail marker from the trail marker register, sets the retrieved URL as the current URL in the web browser, and causes the web browser to navigate to, and display the contents of, the web page at the current URL location in the user interface window 100. Having displayed the contents of the URL location previously set as the trail marker, the web browser continues processing at step 208.

If, at step 212, the web browser determines that the activate trail marker icon 104 is not activated, then, at step 218, the web browser determines if the user activates an option to close (i.e., stop executing) the web browser. If the user activates an option to stop execution of the web browser, the web browser ends at step 222. In one embodiment, the web browser may initialize the web browser register to a default location before terminating. In another embodiment, the web browser may initialize the web browser register to a NULL value before terminating.

If, at step 218, the web browser determines that the user did not activate an option to close the web browser, then, at step 220, the web browser performs the normal browser operation (e.g., a browser operation other than set or activate trail marker) specified by the user. For example, the user may have specified a URL through the user interface window 100. The web browser can then navigate to the URL specified by the user, and display the contents found at the URL location to the user in the user interface window 100. Having performed the normal browser operation, the web browser continues processing at step 208.

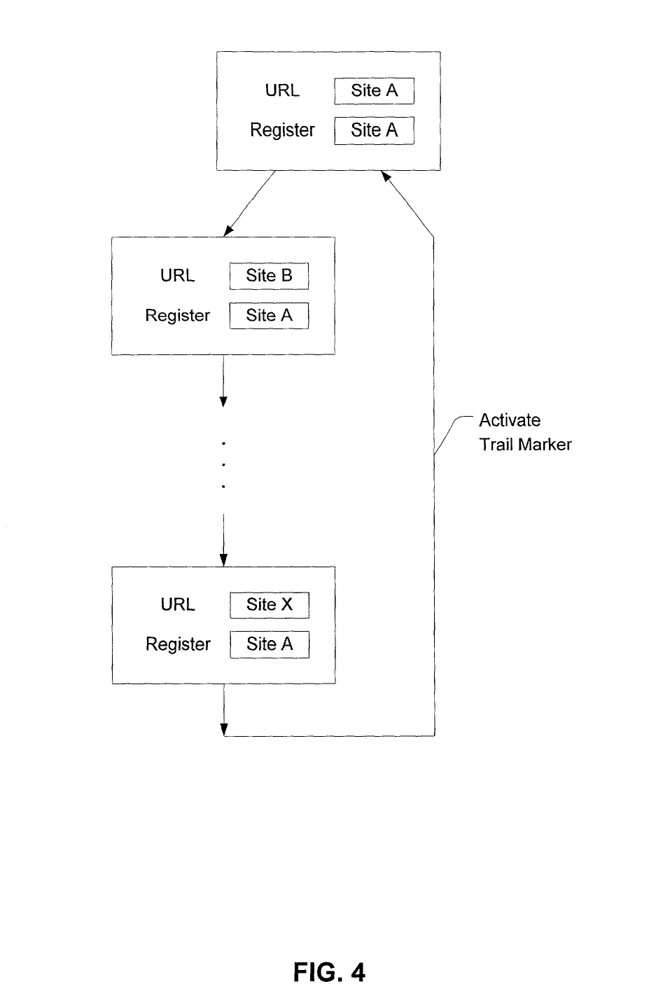

FIG. 4 illustrates an exemplary browsing session in which a trail marker is activated, according to one embodiment. In the figure, “URL” designates the location whose contents are currently displayed in a web browser, and “Register” designates the location that is set as a trail marker or temporary bookmark. During a user's browsing session, both the URL and the Register are set to “Site A.” For example, assuming that Site A is the user's home page, when the user first starts a browsing session (e.g., when the web browser first starts executing), the web browser displays the contents of Site A (URL=Site A) and initializes the trail marker to Site A (Register=Site A).

Subsequently, the user uses the web browser to navigate to “Site B” (URL=Site B), which causes the web browser to display the contents of Site B. Assuming the user did not alter the trail marker, the trail marker remains set to Site A (Register=Site A). The user can use the web browser to navigate to many locations, including “Site X” (URL=Site X). Assuming the user did not alter the trail marker or, if the user did alter the trail marker by setting it to another location, the user reset the trail marker to Site A, the trail marker remains set to Site A (Register=Site A). While viewing the contents of Site X, the user may decide he or she wants to navigate back or return to the trail marked location (Register=Site A). The user can then select, for example, an option on the web browser to activate the trail marker. Activating the trail marker causes the web browser to navigate to the trail marked location (URL=Site A) and to display the contents found at that location. The trail marker remains set to Site A (Register=Site A).

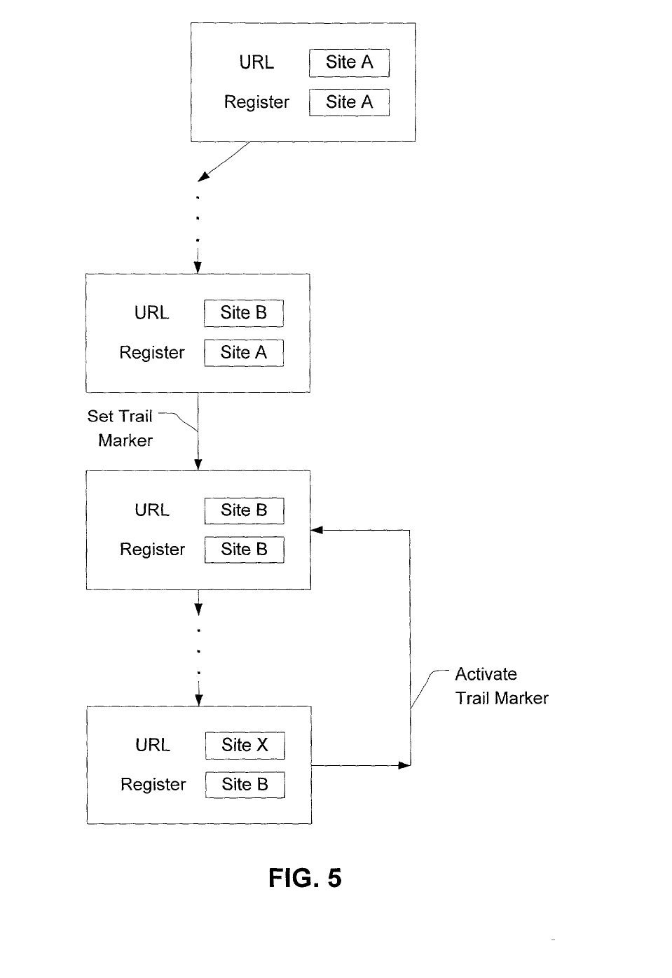

FIG. 5 illustrates an exemplary browsing session in which a trail marker is set and subsequently activated, according to one embodiment. As in FIG. 4, “URL” designates the location whose contents are currently displayed in a web browser, and “Register” designates the location that is set as a trail marker or a temporary bookmark. A user can navigate to many locations during a browsing session. During the user's browsing session, both the URL and the Register are set to Site A.

Subsequently, the user uses the web browser to navigate to Site B (URL=Site B), which causes the web browser to display the contents of Site B. Assuming the user did not alter or set the trail marker, the trail marker remains set to Site A (Register=Site A). The user views the displayed contents and decides that he or she might want to return to this location during the current browsing session. The user wants to create a temporary bookmark that is only enabled for the duration of the current browsing session. The user can select, for example, an option on the web browser to set the trail marker to the current network location (Register=Site B).

The user can use the web browser to navigate to many locations, including “Site X” (URL=Site X). Assuming the user did not alter the trail marker or, if the user did alter the trail marker by setting it to another location, the user reset the trail marker to Site B, the trail marker remains set to Site B (Register=Site B). While viewing the contents of Site X, the user may decide he or she wants to navigate back to the trail marked location. The user can select, for example, an option on the web browser to activate a return to the trail marked location. Activating the trail marker causes the web browser to navigate to the trail marked location (URL=Site B) and to display the contents found at that location. The trail marker remains set to Site B (Register=Site B).

As described herein, the present invention in at least one embodiment, provides an option to set a location as a temporary bookmark or trail marker during a browsing session, and a further option to return to the location set as the temporary bookmark or trail marker during the same browsing session. One embodiment of the present invention provides a user the ability to set a URL as a trail marker by clicking on an icon on a web browser. The user can then use the web browser to navigate to other URLs. When the user wants to return to the trail marked URL, the user clicks on an icon on the web browser, which causes the web browser to navigate to the trail marked URL location and display the contents at the URL location.

In at least one embodiment, the present invention provides a user the ability to return to a previously visited web page with a single click of a button or icon. For example, a user can use a web browser that provides the trail marker functionality to visit a company's product web site. The user can further navigate deep within the company's web site structure until the user finds a web page containing information about a desired product. The user is almost ready to put the product in the user's “shopping cart” when the user remembers that he or she wanted to check out a competitor's web site. The user does not want to set a bookmark for this simple product web page, but the user realizes that it was difficult getting to the current web page from the company's home page. Thus, the user can set a temporary trail marker that allows the user to come back to this web page in the future, during the current browsing session. The user can then navigate to the competitor's web site. The user browses through many product web pages (e.g., tens or hundreds of web pages) but fails to find a comparable product. Having searched through the competitor's products, the user may now want to return to the first company's web site to purchase its product. Having set the trail marker, the user can easily and directly return to the first company's product web page by simply clicking on a button or icon. The user can then continue where he or she left off and finish purchasing the product.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

What is claimed is:

1. A web browser trail marker system comprising:
a computer;
a memory operable to store a single reference to a web page; and
a browser coupled to the memory and operable to execute on the computer, the browser comprising a first button and a second button, wherein the browser, responsive to activation of the first button, stores a reference to a currently accessed web page in the memory, and wherein the browser, responsive to activation of the second button, accesses a web page referenced by the reference stored in the memory.

2. The system of claim 1, wherein the reference is a URL.

3. The system of claim 1, wherein the reference is a string identifying a web page, the string being used to access the web page.

4. The system of claim 1, wherein the memory is reset to a default reference each time the browser is started.

5. The system of claim 4, wherein the default reference being a reference to a home page.

6. A method for providing web browser trail markers comprising:
providing a memory location operable to store a reference to electronic content;
providing a user interface operably coupled to the memory location, the user interface comprising a first button and a second button, the user interface operable to display electronic content;
displaying a first electronic content in the user interface; the first electronic content located at a first reference;
storing the first reference in the memory location in response to activation of the first button;
displaying a second electronic content in the user interface, the second electronic content located at a second reference; and
displaying the first electronic content reference by the first reference stored in the memory location in response to activation of the second button.

7. The method of claim 6 further comprising storing a third reference to a third electronic content in the memory location in response to activation of the first button, wherein the third electronic content being currently displayed in the user interface.

8. The method of claim 6, wherein the reference comprises a URL.

9. The method of claim 6, wherein the reference comprises an address to electronic content.

10. The method of claim 6, wherein the user interface is a web browser.

11. The method of claim 6, wherein the electronic content is a web page.

12. The method of claim 6 further comprising initializing the memory location to a default reference upon starting the user interface.

13. A computer-readable storage medium having stored thereon computer instructions that, when executed by a computer, cause the computer to:
store a first reference to a first electronic content in a memory location, wherein the memory location being operable to store a single reference;
display a second electronic content on a user interface, the second electronic content being associated with a second reference;
provide a first button and a second button on the user interface; and
display the first electronic content referenced by the first reference stored in the memory location on the user interface in response to activation of the first button.

14. The computer-readable storage medium of claim 13 further comprising computer instructions that, when executed by a computer, cause the computer to store a third reference to a third electronic content in the memory location in response to activation of the second button, wherein the third electronic content being currently displayed on the user interface.

15. The computer-readable storage medium of claim 13, wherein the user interface is a web browser.

16. The computer-readable storage medium of claim 13, further comprising computer instructions that, when executed by a computer, cause the computer to retrieve the first electronic content over the Internet.
